(19) United States
(12) Patent Application Publication
(10) Pub. No.: US 2006/0138213 A1
(43) Pub. Date: Jun. 29, 2006

(54) Control unit of a cash transaction machine and multi channel connecting device

(76) Inventors: Hyun Kook Kang, Kwangju-si (KR); Oh Il Kwon, Anyang-si (KR)

Correspondence Address: FISH & RICHARDSON P.C., P.O. BOX 1022, MINNEAPOLIS, MN, 55440-1022, US

(21) Appl. No.: 11/242,950

(22) Filed: Oct. 5, 2005

(30) Foreign Application Priority Data
Dec. 28, 2004 (KR) 10-2004-0114293
Dec. 29, 2004 (KR) 10-2004-0114921

(51) Int. Cl. G07F 19/00

(52) U.S. Cl. 235/379

(57) ABSTRACT

Disclosed is a control unit of a cash transaction machine with various kinds of connection ports or data storage devices arranged at a front face of the control unit, and a multi channel connecting device. In the control unit of the cash transaction machine, main connection ports and data storage devices are arranged at a front face of a main body of the control unit, thereby improving the convenience of the cash transaction machine. Thus, in spite of a narrow inner space of the cash transaction machine, an administrator can manipulate all functions of the system using the ports and other devices arranged at the front face of the main body, and can perform inspection and maintenance without the process of dismounting and reassembling the main body from and to the cash transaction machine. Further, complicated wiring in the cash transaction machine can be simply arranged using the multi channel connecting device.

### CROSS REFERENCE TO RELATED APPLICATION

This application claims priority under 35 USC § 119 to Korean Patent Application No. 10-2004-114293 filed on Dec. 28, 2004 and Korean Patent Application No. 10-2004-114921 filed on Dec. 29, 2004, the contents of which are incorporated herein by reference in their entireties.

### TECHNICAL FIELD

The present invention relates to a control unit of a cash transaction machine, and more particularly, to a control unit of a cash transaction machine and a multi channel connecting device, which allow system inspection and maintenance to be easily performed and can be conveniently utilized by an administrator.

### BACKGROUND ART

A cash transaction machine is a device that is developed to provide basic banking services except counseling works in an unmanned manner and in a rapid and convenient manner without regard to time.

A cash transaction machine includes a cash dispenser for a withdrawal and an automatic teller machine for a withdrawal and a depositing. The cash dispenser has been developed at an initial stage of the electronic banking services to automatically withdraw only cash, whereas the automatic teller machine has a deposit function as well as the cash dispensing function of the cash dispenser.

FIG. 1 is a perspective view illustrating a conventional cash transaction machine.

Referring to FIG. 1, a control unit of the conventional cash transaction machine has the same configuration as a general personal computer (PC). Therefore, I/O ports and various kinds of slots are installed on one side of the cash transaction machine, while a floppy disk drive, an optical drive, various kinds of switches and the like are installed on the other side thereof.

Since devices are frequently mounted into or dismounted from the cash transaction machine, a main body 10 of the control unit is installed in such a manner that it can be slid in the cash transaction machine like a drawer. Further, a rear side of the main body 10 is arranged to face the outside such that various kinds of cables 12 are exposed. Thus, in a case where the floppy disk drive, the optical drive, various kinds of the switches and the like should be manipulated to change or update firmware of the cash transaction machine, the main body 10 should be moved forward (in a direction designated by @).

Further, since cash deposit/withdrawal module, a check deposit/withdrawal module, a card reading module, a bankbook printing module, a display module and the like should be installed in the conventional cash transaction machine, the internal configuration of the cash transaction machine is very complicated. Furthermore, if the cables 12 are arranged complicatedly on the main body 10 of the control unit to be exposed forward, it looks poor externally. In addition, since various kinds of cables 12 may be entangled with one another, there is inconvenience in that they should be put in order every manipulation. Moreover, since the main body 10 should be mounted or dismounted when system inspection and maintenance are performed, failure may occur due to the entanglement of the cables.

To put the cables in order, the main body may be arranged inversely in such a manner that the disk drives and the like are exposed. At this time, since the cables are positioned within the main body, the cables can be neatly put in order. However, if a number of connection ports are disposed on the rear side of the main body, a rear space is too narrow. Thus, it is very inconvenient to perform operations for connecting the cables to the connection ports in such a narrow space. Accordingly, it is very difficult and troublesome to put the cables in order.

### DISCLOSURE OF INVENTION

The present invention provides a control unit of a cash transaction machine, wherein various kinds of connection ports and data storage devices are mounted onto a front surface of a main body thereof.

The present invention provides a control unit of a cash transaction machine, which includes a control panel mounted with a control switch section for allowing peripheral devices of the cash transaction machine to be externally operated.

The present invention provides a multi channel connecting device including a plurality of connection ports, and a control unit including the multi channel connecting device.

The present invention provides a multi channel connecting device by which cables can be easily put in order.

A control unit of a cash transaction machine according to the present invention comprises a main body, main connection ports, and data storage devices. The main body includes a central processing section for controlling the cash transaction machine so as to execute instructions corresponding to a variety of programs. Therefore, the central processing section can perform the functions of receiving and processing input data, storing the processed data, searching the stored data, and outputting the searched results. Further, various kinds of processing devices and storage devices may be contained in the main body, and a variety of functions may be added depending on designer's intention. The main connection ports are mounted in a front face of the main body and are formed on a main board to allow a keyboard, a mouse, a monitor and the like to be electrically connected to the central processing section. The data storage devices are mounted to be partially exposed at the front face of the main body, and read information stored in a storage medium inserted thereinto. One or more data storage devices are provided. The control unit may further comprise a control panel that supports a lower portion of the main body and is mounted with a switch section for operating additional functions of the cash transaction machine at a front face of the control panel.

In a conventional cash transaction machine, since a main body thereof should be mounted or dismounted upon inspection and maintenance of the system, there is a possibility that failure may occur. Particularly, the main body can be considered to be a kernel component of the cash transaction machine. Thus, it is preferred that the main body be subjected to engineering manipulation without mounting or dismounting thereof if it is allowable. Accordingly, since the plurality of main connection ports and data storage devices are mounted on the front face of the main body in the control unit of the present invention, it is not necessary to mount or dismount the main body during system inspection. Consequently, the control unit of the present invention has advantages in that operations for system inspection are conveniently performed, and the control unit is stable since it is possible to eliminate a possibility of failure that may occur during a process of mounting or dismounting the main body. Further, since the switch section for controlling peripheral devices of the cash transaction machine is formed on the front face of the control panel, all functions of the cash transaction machine can be easily controlled on the front face of the main body. Thus, the control system can be more conveniently managed during system inspection and maintenance.

According to another aspect of the present invention, a control unit of a cash transaction machine may comprise a main body, a main board and an extension card. The main body includes a central processing section for controlling the cash transaction machine. The main board is mounted within the main body, and includes a central processor, a memory, main connection ports electrically connected to the central processor and exposed at a front face of the main body, and a card slot electrically connected to the central processor and arranged on the front face of the main body. The extension card is mounted in the card slot of the main board and includes an extension connection port exposed at the front face of the main body. Therefore, peripheral devices can be easily connected through the main connection ports and the extension connection port formed on the front face of the main body.

According to a further aspect of the present invention, a multi channel connecting device comprises a body, connection ports, a circuit section, and a multi connection section. The body of the connection device is formed close to a main device and disposed such that peripheral devices are electrically connected to the main device. The connection ports are formed on a front face of the body so that a user can conveniently use them. The plurality of connection ports may be arranged in sequence. The circuit section is mounted in the body and is electrically connected to the connection ports. The multi connection section is electrically connected to the circuit section and connects the connection ports to the main device. Thus, the multi channel connecting device is electrically connected to the main device through the plurality of connection ports.

In conventional peripheral devices and main device, they are connected to each other mainly using cables and the main device is constructed to have connection ports concentrically arranged thereon. Thus, there is a problem in that due to a narrow installation space, it is very inconvenient to perform works for connecting cables to the messy connection ports in the narrow space. Further, this results in a state where the cables are arranged messily. However, since the multi channel connecting device of the present invention is formed separately from a main device and a plurality of cables are connected to connection ports of the multi channel connecting device, they can be conveniently managed and external appearance is aesthetically improved as compared with conventional ones. In addition, contrary to the prior art in which the cables are messily connected to a connection section of the main device, cables are connected to the multi channel connecting device in order, thereby facilitating inspection operations during system inspection.

### BRIEF DESCRIPTION OF DRAWINGS

FIG. 1 is a perspective view illustrating a conventional cash transaction machine;

FIG. 2 is a front view illustrating a control unit of a cash transaction machine according to a first embodiment of the present invention;

FIG. 3 is a plan view illustrating the control unit of a cash transaction machine according to the first embodiment of the present invention;

FIG. 4 is a front view illustrating a control unit of a cash transaction machine according to a second embodiment of the present invention;

FIG. 5 is a partial front view illustrating a control panel of the control unit of a cash transaction machine according to the second embodiment of the present invention;

FIG. 6 is a front view illustrating a multi channel connecting device according to a third embodiment of the present invention;

FIG. 7 is a rear perspective view illustrating a rear face of the multi channel connecting device according to the third embodiment of the present invention;

FIG. 8 is a perspective view illustrating a body of the multi channel connecting device according to the third embodiment of the present invention;

FIG. 9 is a perspective view illustrating a connection configuration of the multi channel connecting device according to the third embodiment of the present invention;

FIG. 10 is a front view of a control unit of a cash transaction machine according to a fourth embodiment of the present invention; and

FIG. 11 is a plan view of the control unit of a cash transaction machine according to the fourth embodiment of the present invention.

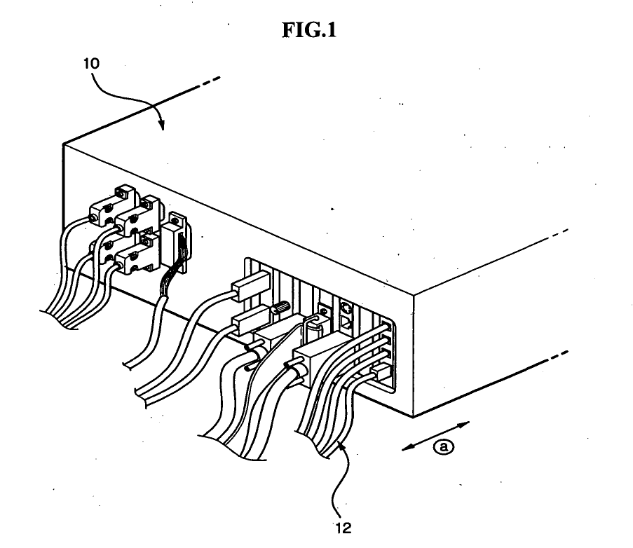

### BEST MODE FOR CARRYING OUT THE INVENTION

Hereinafter, preferred embodiments of the present invention will be described in detail with reference to the accompanying drawings. However, the present invention is not limited to the embodiments.

### First Embodiment

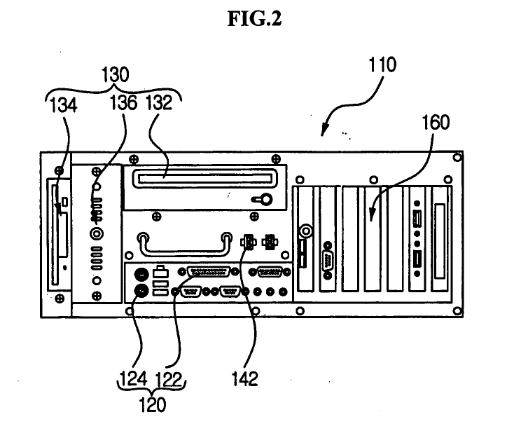

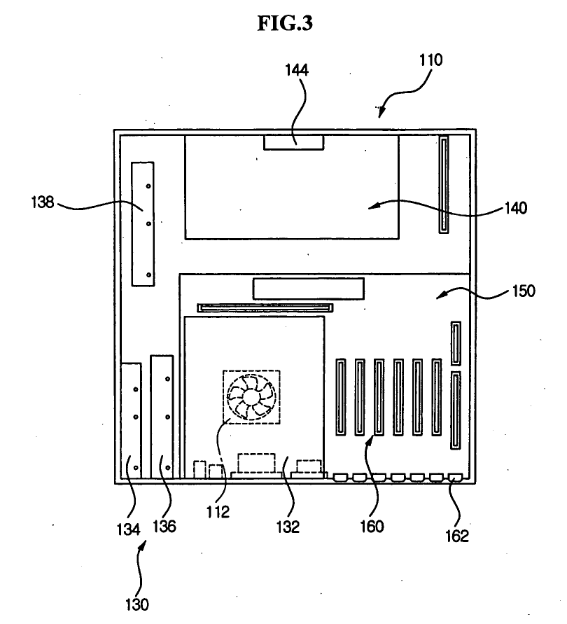

FIG. 2 is a front view illustrating a control unit of a cash transaction machine according to a first embodiment of the present invention, and FIG. 3 is a plan view illustrating the control unit of a cash transaction machine according to the first embodiment of the present invention.

Referring to FIGS. 2 and 3, the control unit of a cash transaction machine comprises a main body 110, main connection ports 120, data storage devices 130, a voltage down transformer section 140, a main board 150, and card slots 160.

The main body 110 is contained within a case of the cash transaction machine and functions to control the cash transaction machine. The main body 110 is mounted with the main board 150 including a central processing section 112 for controlling the cash transaction machine, and a first hard disk storage section 136 and a second hard disk storage section 138 are contained within the main body 110. The voltage down transformer section 140 is contained within the main body in the vicinity of a rear face thereof. Thus, the main body 110 performs the functions of receiving and processing input data, storing the processed data, searching the stored data, and outputting the searched results. Further, modules with various kinds of functions are electrically connected to the central processing section 112 through the main board. The functions of the modules are operated under the control of the central processing section 112.

The main connection ports 120 are disposed at a lower portion of a front face of the main body 110. At this time, the main connection ports 120 include a monitor main connection port 122 for electrically connecting a monitor to the main board, a mouse connection port 124 for electrically connecting a mouse to the main board, a printer connection port for electrically a printer to the main board, and the like. Thus, an administrator can connect these peripheral devices to the various connection ports 120 formed on the front face of the main body 110. However, in other embodiments of the present invention, according to designer's intention, a variety of connection ports may be mounted, or these connection ports may be omitted and then replaced with other connection ports.

The data storage devices 130 are mounted on the front face of the main body 110. The data storage devices 130 include an optical drive 132 and a floppy disk drive 134. The optical drive 132 functions to recognize data that are stored in a CD as a data storage medium inserted thereinto. Likewise, the floppy disk drive 134 is also mounted in the front face of the main body 110 and recognizes data stored in a floppy disk. In other embodiments of the present invention, however, drives as various storage means may be further mounted according to designer's intention. The first hard disk storage section 136 is contained within the main body 110 and the second hard disk storage section 138 is contained within the main body 110 in the vicinity of the front face thereof, so that their entrances are formed at the front face of the main body 110. Thus, since the hard disk can be exchanged at the front face of the main body 110, there is no need for dismounting/mounting the main body 110 from/to the cash transaction machine to exchange the hard disk. However, in other embodiments of the present invention, according to designer's intention, only one hard disk may be used or a plurality of storage spaces may be designed.

The voltage down transformer section 140 is contained in the main body 110, and a power input section 142 is formed in the front face of the main body 110. The voltage down transformer section 140 receives DC power of 24V through the power input unit 142 and distributes it into power of 12V, 5V, 3V and the like so as to supply power required for the main board, the data storage devices, a fan and the like. Therefore, it is not necessary to employ an additional AC converter section, resulting in convenient use. A transformer section fan 144 is formed in a rear face of the voltage down transformer section 140 and serves to cool the transformer section of which the temperature rises. However, in other embodiments of the present invention, according to designer's intention, it is possible to use a DC conversion section for converting AC power into DC power.

The main board 150 is mounted within the main body 110, and includes the central processing section 112, the memory, the main connection ports electrically connected to the central processing section 112 and exposed at the front face of the main body 110, and the card slots 160 electrically connected to the central processing section 112 and disposed at the front face of the main body 110.

The card slots 160 are devices for extension of a video card, a sound card, a LAN card and the like, and mean slots into which various cards are to be inserted. The card slots 160 are formed in the vicinity of the central processing section 112. Various cards are connected to the main board in the main body 110 through the card slots 160. Extension connection ports 162 for use in connecting peripheral devices are formed in the front face of the main body 110.

Therefore, all of the plurality of main connection ports 120, the plurality of data storage devices 130, the power input section 142 of the voltage down transformer section 140, the main board 150 and the extension connection ports 162 are provided at the front face of the main body 110. Accordingly, since an administrator can manipulate the entire system at the front face of the main body 110, it is not necessary to disassembly or assembly the main body 110 during system inspection. Further, since the main body 110 does not need to be dismounted or mounted, all internal functions can be stably protected. In addition, since all the main connection ports 120 are concentrically disposed at a lower portion of the front face of the main body 110, cables can be conveniently managed and simplified and external appearance is aesthetically improved as compared with the prior art.

### Second Embodiment

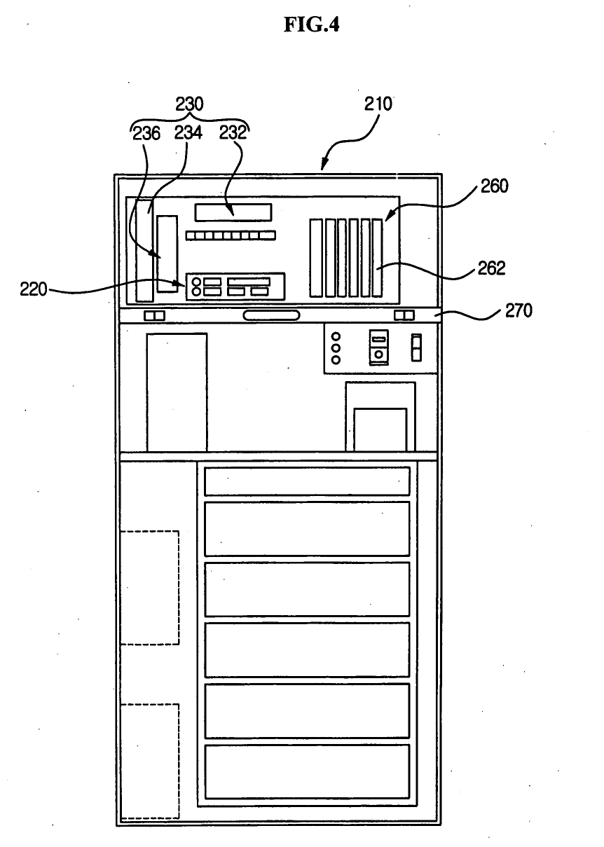

FIG. 4 is a front view illustrating a control unit of a cash transaction machine according to a second embodiment of the present invention, and FIG. 5 is a partial front view illustrating a control panel of the control unit of a cash transaction machine according to the second embodiment of the present invention.

Referring to FIGS. 4 and 5, the control unit of a cash transaction machine comprises a main body 210, main connection ports 220, data storage devices 230, a DC conversion section 240, a main board 250, card slots 260, and a control panel 270.

The main body 210 is contained within a case of the cash transaction machine and functions to control the cash transaction machine. The main body 210 includes a central processing section for controlling the cash transaction machine, has a hard disk drive section 236 contained therein, and is formed with the DC conversion section 240 at a position in contact with a rear face of the main body 210. Further, various kinds of processing sections are electrically connected to a central processing section 212 through the main board 250 and are operated under the control of the central processing section 112.

The main connection ports 220 are disposed at a lower portion of a front face of the main body 210. At this time, the main connection ports 220 may include a monitor main connection port for electrically connecting a monitor to the main board, a mouse connection port for electrically connecting a mouse to the main board, and a printer connection port for electrically connecting a printer to the main board. Thus, an administrator can connect these devices to the various connection ports 220 formed on the front face of the main body 210.

The data storage devices 230 are mounted on the front face of the main body 210. The data storage devices 230 include an optical drive 232 and a floppy disk drive 234. The optical drive 232 functions to recognize data that are stored in a CD as a data storage medium inserted thereinto. The floppy disk drive 234 recognizes data stored in a floppy disk. The hard disk drive section 236 is contained within the main body 210 in the vicinity of the front face thereof. Thus, since the hard disk drive can be exchanged at the front face of the main body 210, there is no need for dismounting/mounting the main body 210 from/to the cash transaction machine to exchange the hard disk.

The DC conversion section 240 is contained within the main body 210, and a power input section 242 is formed at the front face of the main body 210. The DC conversion section 240 receives AC power through the power input section 242 and then converts it into DC power.

The main board 250 is mounted within the main body 210, and includes the central processing section 212, a memory, the main connection ports 210 electrically connected to the central processing section 212 and exposed at the front face of the main body 210, and the card slots 260 electrically connected to the central processing section 212 and disposed at the front face of the main body 210. Therefore, peripheral devices can be connected to the main board 250 through the main connection ports 210 and an extension connection port 262, thereby enabling extension of functions.

The card slots 260 are devices for extension of the peripheral devices such as a video card, a sound card and a LAN card, and mean slots into which the peripheral devices are to be inserted. Although six card slots 260 are formed in this embodiment of the present invention, there is no limitation on the number of the card slots.

The control panel 270 supports a lower portion of the main body 210, and includes a first switch 272, a second switch 274 and a display section 276. The first switch 272 is formed in a front face of the control panel 270 to enable selection of a normal mode or an inspection mode. The normal mode means a state where the system is operated to perform normal transactions, and the inspection mode means a state where an operator or administrator of the system stops transactions during system inspection. Therefore, the operator or administrator can set the first switch 272 to the normal mode or the inspection mode. At this time, the inspection mode is performed according to a principle in which when the first switch 272 is moved to the inspection mode, a signal is inverted, the inverted signal is detected, the change in mode is identified, and the configuration of a picture on a screen and the operation of the system are immediately changed to the inspection mode. The second switch 274 is mounted in the front face of the control panel 270. In a state where a main power supply is applied, the manipulation of the second switch 274 turns on/off the main body 210. Therefore, the main body 210 generates a safe termination command in response to an off signal and accordingly terminates the system. The display section 276 is formed at the front face of the control panel 270, thereby displaying a communication state to the outside. An LED lamp is used for the display section 276 and may be flickered to facilitate determination on a communication state. However, in other embodiments of the present invention, according to designer's intention, a variety of lamps may be used for the display section.

Therefore, since the control panel 270 supports a lower portion of the main body 210 and is provided with the first and second switches 272 and 274 and the display section 276, which control peripheral devices of the cash transaction machine, the function of the cash transaction machine can be easily manipulated. Further, the cash transaction machine can be neatly constructed in external appearance.

### Third Embodiment

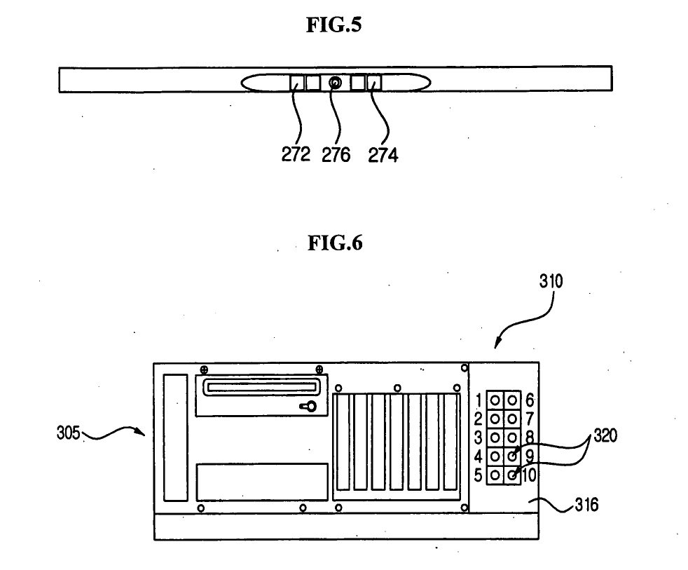

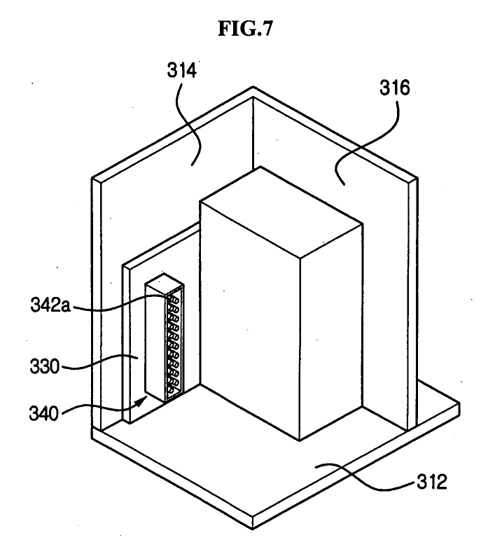

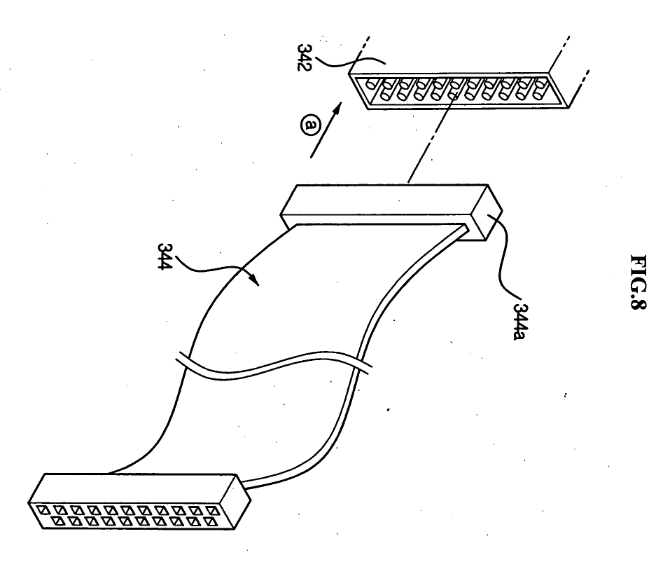

FIG. 6 is a front view illustrating a multi channel connecting device according to a third embodiment of the present invention, FIG. 7 is a rear perspective view illustrating a rear face of the multi channel connecting device according to the third embodiment of the present invention, and FIG. 8 is a perspective view illustrating a body of the multi channel connecting device according to the third embodiment of the present invention.

Referring to FIGS. 6 to 8, the multi channel connecting device comprises a body 310, connection ports 320, a circuit section 330 and a multi connection section 340.

The body 310 is formed close to one side of a main device 305, and the plurality of connection ports 320 are formed in a front face of the body 310. Here, the main device 305 means a main body of a cash transaction machine. However, in other embodiments of the present invention, according to designer's intention, it is possible to use a main body of a computer system applicable to a variety of fields. The body 310 comprises a bottom face 312, a side face 314 and the front face 316. The bottom face 312 is fixedly connected to a frame for mounting the main device 305 thereon and has a hole or a cut-away portion through which cables pass. Therefore, the cables pass through the hole or the cut-away portion from a position below the body 310 and are then connected to the connection ports 320. However, in other embodiments of the present invention, according to designer's intention, the hole or the cut-away portion may be omitted. The front face 316 is formed perpendicularly to the bottom face 312 and provided with the plurality of connection ports 320. The side face 314 is connected to the front face 316 to be perpendicular thereto. Therefore, the body 310 is formed to be open at a side such that it is electrically connected to the main device 305. However, in other embodiments of the present invention, according to designer's intention, the body may be made into various forms such as a hexahedron.

The plurality of connection ports 320 are formed in the front face 316 of the body 310. Cables of peripheral devices are electrically connected to the connection ports 320. Further, ten (10) connection ports 320 are arranged, in two rows each of which has five (5) connection ports thereon, in the front face 316 of the body 310, and are numbered from 1 to 10. Thus, a user can correctly identify the kinds of the cables by checking the denoted numbers. However, there is no limitation on the number of the connection ports 320. According to designer's intention, the number of the connection ports 320 can be set variously.

The circuit section 330 is positioned close to the side face 314 of the body 310 and electrically connected to the plurality of connection ports 320. Therefore, the connection ports 320 allow peripheral devices to be electrically connected to the main device 305. The multi connection section 340 is mounted on the front face of the circuit section 330. The circuit section 330 includes an intermediate processing section connected to the connection ports 320. The intermediate processing section functions to encrypt information to be transmitted to the connection ports 320 and to convert it into a predetermined signal. Thus, the intermediate processing section electrically connects the main device 305 and peripheral devices to each other so that they are compatible with each other.

The multi connection section 340 is electrically connected to the connection ports 320 through the circuit section 330, and includes a multi port 342 and a multi cable 344. The multi port 342 is provided therein with a plurality of connection pins 342a that are to be electrically connected to the connection ports 320. The multi cable 344 has an end formed with terminals 344a corresponding to the multi port 342, and electrical connection is made while the terminals 344a are connected to the connection pins 342a. The multi cable 344 is formed by binding respective cables arranged in order into a single cable.

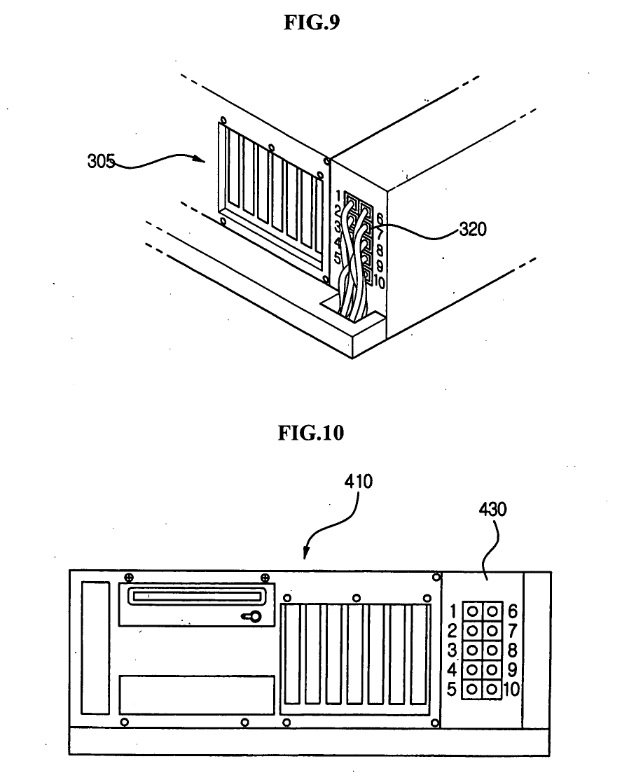

FIG. 9 is a perspective view illustrating a connection configuration of the multi channel connecting device according to the third embodiment of the present invention.

Referring to FIG. 9, the multi cable 344 electrically connects the main device 305 and the multi channel connecting device to each other. The multi port 342 is electrically connected to the connection ports 320 formed in the front face of the multi channel connecting device and is then disposed within the body 310. The terminals 344a of the multi cable 344 are inserted into the multi port 342 and the other ends thereof are inserted into slit portions of the main device 305, thereby electrically connecting the main device 305 and the multi channel connecting device to each other. Therefore, with the use of the multi channel connecting device, it is easy to electrically connect peripheral devices and to manage the system. Further, since the cables are connected to the multi channel connecting device in order, contrary to the prior art in which cables are messily connected to the connection ports of the main device 305, an inspection operation can be easily performed during system inspection, management of the system can be performed conveniently, and external appearance is aesthetically superior to a conventional one.

### Fourth Embodiment

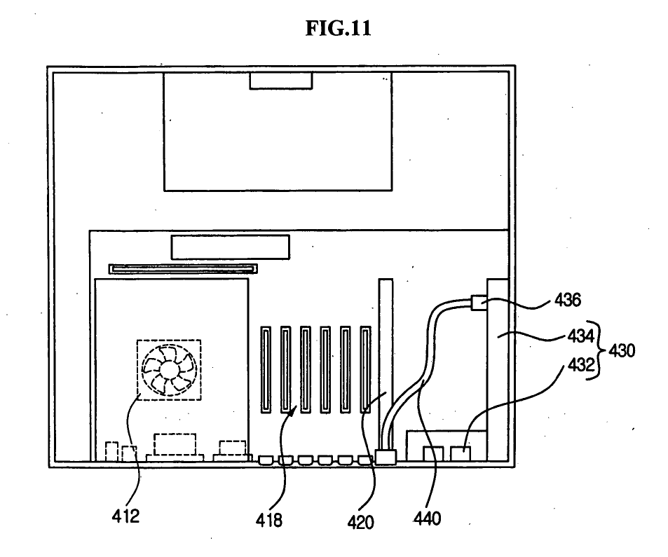

FIG. 10 is a front view of a control unit of a cash transaction machine according to a fourth embodiment of the present invention, and FIG. 11 is a plan view of the control unit of a cash transaction machine according to the fourth embodiment of the present invention.

Referring to FIGS. 10 and 11, the control unit of the cash transaction machine comprises a main body 410, an integrated connection module 420, a multi channel connecting device 430, and a multi cable 440.

The main body 410 is contained within a case of the cash transaction machine and functions to control the cash transaction machine. The main body 410 includes a central processing section 412 for controlling the cash transaction machine and has a hard disk storage section and a conversion section contained therein. Thus, the main body 410 performs the functions of receiving and processing input data, storing the processed data, searching the stored data, and outputting the searched results. However, in other embodiments of the present invention, according to designer's intention, the main body may be a main body for a variety of devices. Further, various kinds of processing sections are electrically connected to the central processing section 412 through a main board and are operated under the control of the central processing section 412. In addition, a slot section 418 is formed in the main board. At this time, the slot section 418 is a device for extension of peripheral devices such as a video card, a sound card, a LAN card and the like, and means slots into which the peripheral devices are to be inserted. Moreover, the integrated connection module 420 can be inserted into and electrically connected to the slot section 418. However, in other embodiments of the present invention, according to designer's intention, the main body may include modules with a variety of functions.

The integrated connection module 420 is mounted on the main body and connects the peripheral devices to the central processing section 412, thereby extending the functions of the peripheral devices. The integrated connection module 420 is connected through the slot section 418 and electrically connected to the multi channel connecting device 430 by means of the multi cable 440.

The multi channel connecting device 430 comprises connections ports 432, a circuit section 434 and a multi port 436. The plurality of connection ports 432 are formed in a front face of the main body 410. The connection ports 432 are electrically connected to cables of the peripheral devices. There is no limitation on the number of the connection ports 432. According to designer's intention, the number of the connection ports 432 can be set variously. The circuit section 434 is electrically connected to the connection ports 432, and the multi port 436 is formed close to the circuit section 434. Therefore, the connection ports 432 are connected to the single multi port 436, and the peripheral devices are electrically connected to the central processing section 412 by means of the multi cable 440. The multi cable 440 is a medium of which both ends are connected to the integrated connection module 420 and the connection ports 432 to connect them. Further, the circuit section 430 includes an intermediate processing section connected to the connection ports 432. The intermediate processing section functions to encrypt information transmitted from the connection ports 432 or to convert the information into a predetermined signal. Therefore, the intermediate processing section electrically connects the main body 410 and the peripheral devices to each other so that they are compatible with each other.

In the control unit of a cash transaction machine according to the present invention, main connection ports, data storage devices, an input of a conversion section, and the like are formed in a front face of a main body thereof. Thus, an administrator can conveniently manipulate the entire system at the front face of the main body. Further, since it is not necessary to mount and dismount the main body to and from the cash transaction machine, the system can be stably protected during system inspection. Moreover, since all connection ports are concentrically arranged at a lower portion of the front face of the main body, the cables can be conveniently managed and simplified, resulting in external appearance aesthetically improved over a conventional one.

In addition, since a control panel supporting a lower portion of the main body includes a display section and a switch section for controlling operations of the peripheral devices, all functions can be conveniently manipulated at a region close to the main body.

Furthermore, since the multi channel connecting device of the present invention is formed separately from a main device, and a plurality of cables are connected to connection ports of the multi channel connecting device, the cables can be conveniently managed.

Moreover, contrary to the prior art in which cables are messily connected to a connection section of a main device, cables are connected to the multi channel connecting device in order, thereby facilitating inspection operations during system inspection and improving external appearance aesthetically.

Further, since the control unit of the present invention allows peripheral devices to be connected to the multi channel connecting device in order, it is convenient to manage cables for use in connecting the peripheral devices. In the internal configuration of the control unit, connection is made by one integrated connection module. Thus, electrical connection of a plurality of modules can be easily made.

Although the present invention has been described in connection with the preferred embodiments, it will be readily understood by those skilled in the art that various modifications and changes can be made thereto without departing from the spirit and scope of the present invention defined by the appended claims.

1. A control unit of a cash transaction machine, comprising:
a main body including a central processing section for controlling the cash transaction machine;
one or more main connection ports mounted on front face of the main body; and
a data storage device mounted in the front face of the main body to be partially exposed, for recording information to be transmitted to the central processing section on a data storage medium or transmitting the information to the central processing section.

2. The control unit as claimed in claim 1, further comprising:
a power input section formed at the front face of the main body to receive external AC power; and
a DC conversion section contained within the main body to convert the AC power into DC power.

3. The control unit as claimed in claim 1, further comprising:
a power input section formed at the front face of the main body to receive external DC power; and
a voltage down transformer section contained within the main body to convert the externally supplied DC power into power suitable for internal circuits of the control unit and to supply the converted power to the respective internal circuits.

4. The control unit as claimed in claim 1, wherein the data storage device comprises at least one of an optical disk drive, a floppy disk drive, and a hard disk drive.

5. The control unit as claimed in claim 1, further comprising:
a control panel supporting a lower portion of the main body and having a front face mounted with a switch section for operating an additional function of the cash transaction machine.

6. The control unit as claimed in claim 5, wherein the switch section comprises:
a first switch for use in selecting a normal mode or an inspection mode for inspecting a system; and
a second switch for turning on/off the main body.

7. The control unit as claimed in claim 5, wherein the front face of the control panel is further provided with a display section for displaying a state of communication with the outside.

8. A control unit of a cash transaction machine, comprising:
a main body including a central processing section for controlling the cash transaction machine;
a main board mounted within the main body and including a central processing device, a memory, a main connection port electrically connected to the central processing device and exposed at a front face of the main body, and a card slot electrically connected to the central processing device and arranged at the front face of the main body; and
an extension card mounted in the card slot and including an extension connection port exposed at the front face of the main body.

9. The control unit as claimed in claim 8, further comprising a data storage device mounted in the front face of the main body to be partially exposed so that the data storage device can be mounted and demounted through the front face of the main body.

10. The control unit as claimed in claim 9, wherein the data storage device comprises at least one of an optical disk drive, a floppy disk drive, and a hard disk drive.

11. The control unit as claimed in claim 8, further comprising a control panel supporting a lower portion of the main body and having a front face mounted with a switch section for operating a peripheral device of the cash transaction machine.

12. A multi channel connecting device for electrically connecting peripheral devices to a main device, comprising:
a body;
a plurality of connection ports formed at a front face of the body;
a circuit section mounted in the body and electrically connected to the connection ports; and
a multi connection section electrically connected to the circuit section in correspondence with the respective connection ports to functionally connect the connection ports to the main device.

13. The multi channel connecting device as claimed in claim 12, wherein the multi connection section includes a multi port provided therein with a plurality of connection pins that are to be electrically connected to the respective connection ports.

14. The multi channel connecting device as claimed in claim 13, further comprising a multi cable for electrically connecting the multi port to the main device.

15. The multi channel connecting device as claimed in claim 12, further comprising a protection cover installed at a rear side of the connection ports to protect the connection ports.

16. The multi channel connecting device as claimed in claim 12, wherein the body comprises a front face directed forward, a side face connected to at a side portion of the front face, and a bottom face connected to a lower portion of the front face.

17. The multi channel connecting device as claimed in claim 12, wherein the circuit section further comprises an intermediate processing section electrically connected to the connection ports.

18. A control unit of a cash transaction machine to be electrically connected to a plurality of peripheral devices, comprising:
a main body for controlling the peripheral devices;
an integrated connection module mounted in the main body;
a multi channel connecting device including a plurality of connection ports formed at a front face thereof, a circuit section electrically connected to the connection ports, and a multi connection section electrically connected to the circuit section to electrically connect the connection ports and the integrated connection module to each other; and
a multi cable for electrically connecting the multi connection section and the integrated connection module to each other.

19. The control unit as claimed in claim 18, wherein the multi connection section includes a multi port provided therein with a plurality of connection pins that are to be electrically connected to the respective connection ports.

20. The control unit as claimed in claim 17, wherein the circuit section further comprises an intermediate processing section electrically connected to the connection ports.
